(19) United States
(12) Patent Application Publication
(10) Pub. No.: US 2023/0010022 A1
(43) Pub. Date: Jan. 12, 2023

(54) PERMANENTLY EXCITED ELECTRIC MACHINE

(71) Applicant: KNORR-BREMSE Systeme für Nutzfahrzeuge GmbH, Munich (DE)

(72) Inventors: Noel MATHAE, Stuttgart (DE); Dordo Stankovic, Munich (DE); Zeger Bontinck, Muehlacker (DE)

(21) Appl. No.: 17/854,321

(22) Filed: Jun. 30, 2022

(30) Foreign Application Priority Data
Jul. 8, 2021 (DE) DE102021117625.5

(51) Int. Cl. H02K 1/276

(52) U.S. Cl. CPC H02K 1/2773

(57) ABSTRACT

A permanently excited electric machine including a stator, a rotor rotatable within the stator on a shaft about a rotation axis, an air gap is arranged between a radially outer circumferential surface of the rotor and a radially inner circumferential surface of the stator, recesses formed in a rotor body of the rotor, and permanent magnets received in at least two of the recesses. The at least two recesses that receive the permanent magnets are open towards the air gap.

### RELATED APPLICATIONS

This application claims priority from German Patent Application DE 10 2021 117 625.5 filed on Jul. 8, 2021 which is incorporated in its entirety by this reference.

### FIELD OF THE INVENTION

The invention relates to a permanently excited electric machine.

### BACKGROUND OF THE INVENTION

A generic electric machine is known from DE 10 2013 206 418 A1. Therein grooves are formed in rotor lamellas of a rotor including plural rotor lamellas wherein a permanent magnet is received in the rotor lamellas. Bridges are formed between outer edges of the grooves and an outer profile of the rotor, wherein the bridges bridge the grooves and thereby connect portions of the rotor lamella adjacent to the grooves with one another.

DE 10 2009 047 677 A1 also discloses a generic electric machine. FIG. 1 shows the known prior art electric machine 1 which can be used as an electric motor 2 or a generator 3. The electric machine 1 includes a shaft 5 that rotates about a rotation axis 14. Lamellas 16 enveloped by insulation material are arranged or stacked in an axial direction of the rotation axis 14 on top of one another on the steel shaft 5 to form a lamella packet. The lamellas 16 or the lamella packet include axial recesses 13 (c.f. FIG. 2) in which permanent magnets 15 are arranged. A rotor 4 of the electric machine 1 includes the shaft 5, the permanent magnets 15, the lamellas 16 and two balancing discs 6. The rotor 4 includes a first end section 11 and a second end section 12. A balancing disc 6 is thus arranged respectively at the first end section 11 and the second end sections 12. The balancing disc 6 is made from metal, for example steel, and compensates imbalances on the rotor 4. The balancing disks 6 are provided with a recess 7 at a side. The shaft 5 is supported by a roller bearing 19 at a housing 20 of the electric machine 1. A stator 17 with electromagnets 18 is arranged at the housing 20. An air gap 21 is formed between the stator 17 and the rotor 4.

Due to the axial recesses of the lamellas 16 that support the permanent magnets 15, the permanent magnets 15 are covered by a so-called bridge 22 for each lamella 16 on a radial outside in a cross-sectional plane orthogonal to the rotation axis 14. These bridges 22 of the lamellas 16 therefore fix the permanent magnets 15 in their positions when the rotor 4 rotates about the rotation axis 14. Therefore, the bridges 22 provide mechanical stability to the lamellas 16 by connecting radially outer portions of the lamellas 16 that are adjacent to the permanent magnets 15 with another.

FIG. 2 illustrates a recess 13 in a lamella 16 with a permanent magnet 15 received in the recess 13 and a bridge 22 which is provided in the known prior art electric machine 1 in the portion designated by the dashed circle in the cross-sectional plane orthogonal to the rotation axis 14. Furthermore FIG. 2 also shows the magnetic flux lines 23 of the magnetic field of the permanent magnets 15. This shows that the magnetic flux lines 23 also run along the bridge 22. The bridges 22 therefore cause a magnetic leakage flux and therefore reduce efficiency of the electric machine 1. Removing the bridges 22 in all lamellas 16 could cause structural problems at higher speed of the rotor 4 for the reasons recited supra since rather large centrifugal forces impact the permanent magnets 15.

In particular with electric motors with permanent magnets like brushless DC motors (BLDG) and permanent magnets synchronous motors (PMSM) a concentration of the magnetic flux towards the air gap is desirable in order to efficiently utilize the permanent magnets.

### BRIEF SUMMARY OF THE INVENTION

Thus, it is an object of the invention to improve the generic permanently excited electric machine recited supra to achieve better efficiency combined with high stability. It is another object of the invention to provide a vehicle with the permanently excited electric machine.

The objects are achieved according to the invention by a permanently excited electric machine including a stator, a rotor rotatable within the stator on a shaft about a rotation axis, an air gap is arranged between a radially outer circumferential surface of the rotor and a radially inner circumferential surface of the stator, recesses formed in a rotor body of the rotor, and permanent magnets received in at least two of the recesses. The at least two recesses that receive the permanent magnets are open towards the air gap.

The electric machine can be configured, for example, as an electric motor or as a generator. The permanent magnets are, for example, magnetized to have plural poles.

According to the invention, the recesses, for example, all recesses in which the permanent magnets are received are open towards the air gap. Put differently at least a portion of a radially outer surface of the permanent magnets has a direct connection towards the air gap. This allows omission of the prior art bridges recited supra. Thus, the rotor body is configured without the bridges. These measures reduce the magnetic leakage flux and improve efficiency of the electric machine. The openings may be formed in the radially outer circumferential surface of the rotor body, and the openings lead on a first side into the recesses and on a second side into the air gap. A rim of the openings respectively may protrude in a radial direction of the openings so that the permanent magnets received in the at least two recesses are each respectively partially overlapped by the rim. The permanent magnets may be arranged like spokes about the rotation axis of the rotor. The rotor body includes segments may be made from at least one type of metal, and the segments may be arranged like spokes about the rotation axis of the rotor and may be arranged between the permanent magnets viewed in a circumferential direction in the rotor. The segments may be separate segments. The segments may be respectively made from plural lamellas that are stacked in a direction of the rotation axis to form lamella packets. The segments may be made from steel or include steel. The segments may be connected at radially inner circumferential surfaces of the segments with a hub body that is connected with the shaft at least torque proof. The segments may be connected with the hub body by positive form locking, friction locking or bonding. The hub body may include radially outer hooks that cooperate with complementary hook-shaped recesses at the radially inner circumferential surfaces of the segments so that positive form locking with an undercut cross section is respectively provided between the radially outer hooks and the complementary hook shaped recesses. The hub body may be made from a diamagnetic or paramagnetic material. The hub body may be made from aluminum. The permanently excited electric machine may be implemented as a brushless direct current motor (BLDC). The permanently excited electric machine may be implemented as a permanent magnet synchronous motor (PMSM). The permanently excited electric machine may be included in a vehicle.

In order to prevent the prior art bridges, openings may be formed e.g. at an outer circumferential surface of the rotor body wherein the openings lead on one side into the recesses and on another side into the air gap. In particular no magnetically conductive elements are arranged in the openings.

Thus, an edge of the openings can respectively protrude so that the permanent magnets received in the openings are respectively partially overlapped, in particular by leaving a respective opening uncovered by the edge uncovered. The edges of the openings therefore retain the permanent magnets in the openings at radially outer ends of the permanent magnets by positive form locking. The radially inner ends of the permanent magnets can protrude from the recesses in a radially inward direction and contact a hub body which is connected with the shaft at least torque proof and which supports the rotor body torque proof. Then the permanent magnets are fixed on a radial outside by rims of the openings and fixed at a radial inside by the hub body. The recesses in the rotor body can extend e.g; from the hub body to the openings in the rotor body.

The permanent magnets and in particular the recesses can also be arranged like spokes about the rotation axis of the rotor.

The rotor body can also include segments made from at least one metal which are arranged about the rotation axis of the rotor, wherein the segments are arranged between the permanent magnets viewed in a circumferential direction of the rotor. In particular the segments can be separate segments and can be made respectively from plural lamellas, in particular from steel lamellas. Therefore, the segments can be made from steel or can include steel.

The segments can also be connected with the hub body at radially inner circumferential surfaces of the segments wherein the hub body is connected with the shaft at least torque proof and supports the rotor body torque proof. Therefore, the rotor body is connected with the hub body at least torque proof.

In particular the segments can be connected with the hub body by positive form locking and/or friction locking e.g. by a threaded connection or by clamping and/or they can be bonded e.g. connected by glue joints.

In order to form the positive form locking connection between the hub body and the segments the hub body can include radially outer hooks which cooperate with the complementary hook shaped recesses at the radially inner circumferential surface of the segments so that a respective positive form locking connection with an undercut cross section is formed between the hooks and the recesses respectively.

The positive form locking and/or friction locking and/or bonded connections between the hub body and the segments facilitate in particular implementing the entire rotor body by separate elements arranged like spokes. This segmenting facilitates stamping more material from a steel plate than in the method where the entire rotor portion is stamped in one piece. This improves material utilization during production. Furthermore only one stamping tool is required for stamping als segments or segment plates. Furthermore, the connections keep the segments in position which is particularly important at high rotor speeds.

According to an advantageous embodiment the hub body can be made from a diamagnetic and/or paramagnetic material, in particular aluminum.

According to an advantageous embodiment the permanently excited electric machine can be configured as a brushless DC motor or a as a permanent magnet synchronous motor (PMSM). The invention also relates to a vehicle including the permanently excited electric machine described supra.

### BRIEF DESCRIPTION OF THE DRAWINGS

An advantageous embodiment of the invention is subsequently described with reference to drawing figures, wherein:

FIG. 1 illustrates a prior art embodiment;

FIG. 2 illustrates a prior art embodiment;

FIG. 3 illustrates a schematic cross-sectional view of a rotor of the permanently excited electric machine according to the invention;

FIG. 4 illustrates a detail of FIG. 3, showing a permanent magnet received in a recess of a rotor body of a rotor and magnetic flux lines of the magnetic field of the permanent magnet; and

FIG. 5 illustrates a diagram comparing a torque generated by the electric machine according to the invention at a particular angular position of the rotor with a prior art electric machine.

### DETAILED DESCRIPTION OF THE INVENTION

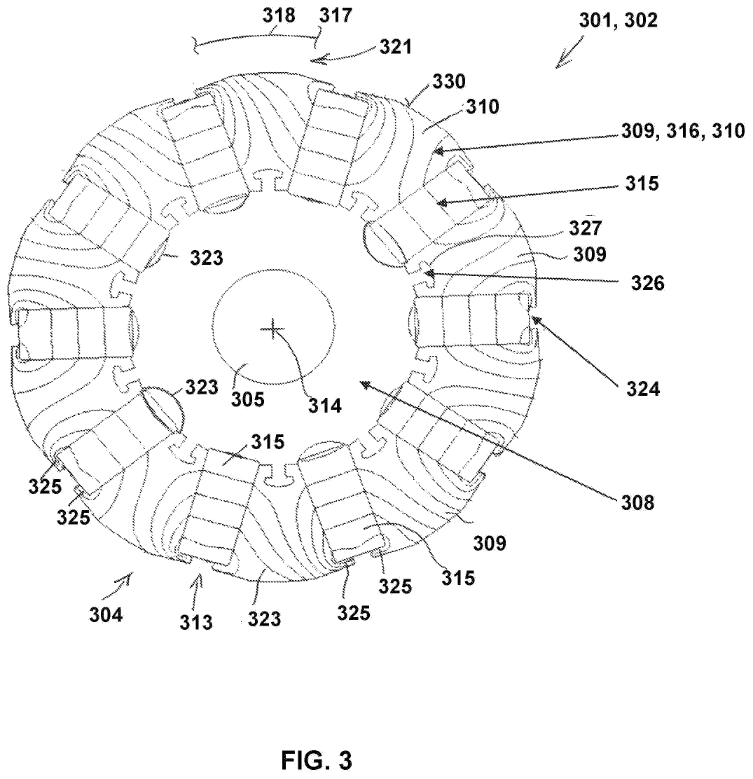

The permanently excited electric machine 301 that is partially shown in FIG. 3, is implemented e.g. as a permanently excited electric motor that is configured e.g. as a brushless DC motor (BLDC) or as a permanent magnet synchronous motor (PMSM).

The electric machine 301 includes a shaft 305 that rotates about a rotation axis 314. A hub body 308 is connected torque proof with the shaft 305 that is e.g. made from steel wherein segments 309 of a rotor body 310 and permanent magnets 315 are supported at the hub body 308. The segments 309 are made e.g. from steel or include steel and are arranged with respect to the rotation axis 314 in a spoke shape or in a radial direction. Advantageously the rotor body 310 is exclusively made from the e.g. separate segments 309.

The advantageously separate segments 309 can be formed in particular by lamellas 316 arranged or stacked on top of each other in the axial direction of the rotation axis 314 to form a lamella packet. The rotor body 310 or the lamellas 316 or the lamella packet include radial recesses 313 in which permanent magnets 315 are arranged. The hub body 308 is connected with the shaft 305 at least torque proof and supports the rotor body 310 torque proof. The hub body 308 can be made from a diamagnetic and/or paramagnetic material, such as from aluminum. A rotor 304 of the electric machine 301 thus includes the shaft 305, the permanent magnets 315, the rotor body 310 thus configured in particular from segments 309 made from lamellas 316, and the hub body 308.

The shaft 305 is supported in bearings at a housing of the electric machine 301. The housing supports a stator 317 with electric magnets 318, wherein the stator is only partially shown. An air gap 321 is formed between the stator 317 and the rotor 304.

Openings 324 are advantageously formed at a radially outer circumferential surface of the rotor body 310 wherein the openings 324 lead on one side into the recesses 313 and on another side into the air gap 321. No magnetically conductive elements are arranged or provided in the openings 324. The openings 324 are therefore formed at or in a radially outer circumferential surface of the rotor body 310 of the rotor 304.

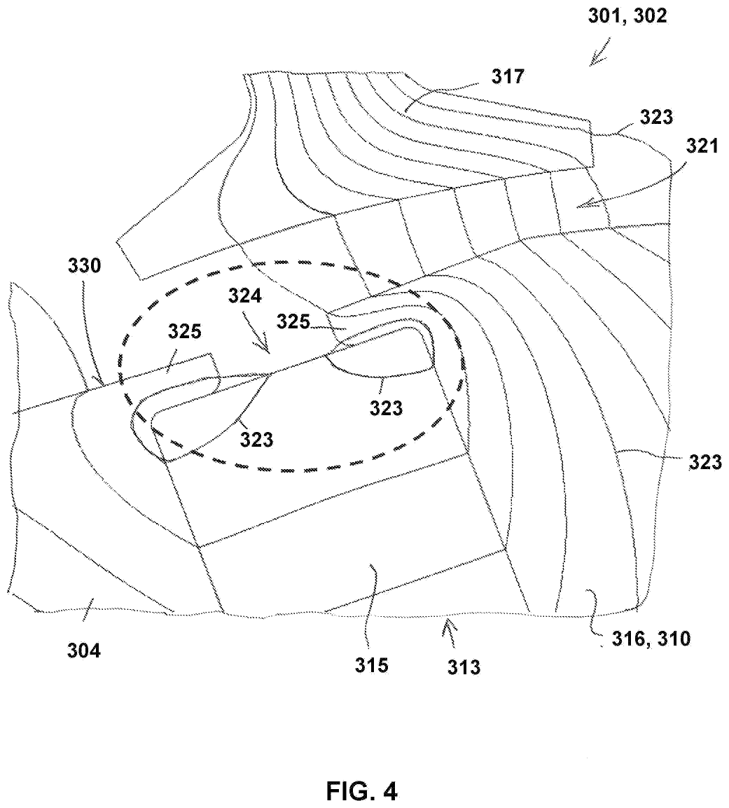

As shown in FIG. 4, an advantageously circumferential rim 325 of the openings 324 respectively protrudes in a radial direction so that the permanent magnets 315 received in the recesses 313 are respectively partially overlapped, in particular with the respective rim 325 leaving the respective opening 324 uncovered. The rims 325 of the openings 324 therefore positively form lock or interlock the permanent magnets 315 at radial outer ends of the permanent magnets 315 in the recesses 313. Radially inner ends of the permanent magnets 315 may protrude from the recesses 313 of the rotor body 310 in a radially inward direction and contact the hub body 308. Then the permanent magnets 315 are fixed on a radial outside by the rims 325 of the openings 324 and are fixed on a radial inside by the hub body 308. The recesses 313 in the rotor body 310 can extend as illustrated in FIG. 3 e.g. from the hub body 308 to the openings 324 in the rotor body 310. Furthermore, the permanent magnets 315 and the recesses 313 are arranged in the rotor body e.g. like spokes about the rotation axis 314 of the rotor 304.

The segments 309 of the rotor body 310 are made from at least one type of metal, advantageously steel and are arranged in a circumferential direction of the rotor 304 respectively between two permanent magnets 315. Furthermore, the permanent magnets 315 are respectively arranged between two adjacent segments viewed in the circumferential direction of the rotor 304.

As evident from FIG. 3 the segments 309 can be connected with the hub body 308 at their radially inner circumferential surfaces. In particular the segments 309 can be connected with the hub body 308 by positive form locking and/or friction locking e.g. by a threaded connection or clamping and/or bonding e.g. by gluing.

In order to form a positive form locking connection between the hub body 308 and the segments 309 the hub body 308 can include hooks 326 on a radial outside as illustrated in FIG. 3, wherein the hooks cooperate with hook shaped recesses 327 at a radially inner circumferential surface of the segment 309 so that a respective positive form locking with an undercut cross section is provided between the hooks 326 and the recesses 327. The hooks 326 protrude in particular in a radially outward direction from the hub body 308.

FIG. 4 illustrates magnetic flux lines 323 of the magnetic field of the permanent magnet 315 received in the recess 313. FIG. 4 illustrates that the magnetic flux lines 323 cannot connect amongst each other and are not interrupted at least on a radial outside due to a lack of the bridge described supra which is provided in the portion indicated by the dashed circle in the prior art and due to the radially outer opening 324 in the rotor body 310 or in the recess 313 that is oriented towards the air gap 321. This reduces magnetic leakage flux and improves efficiency of the permanently excited electric motor 302.

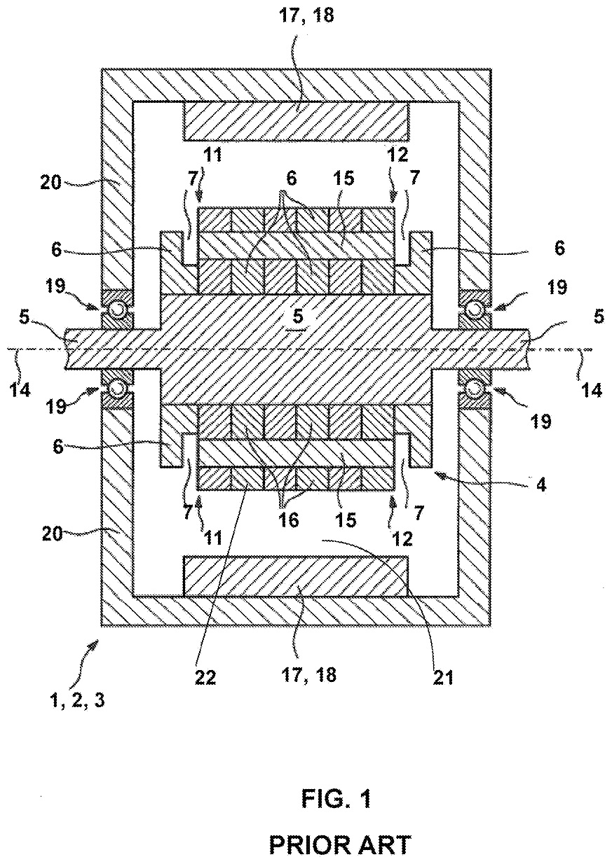

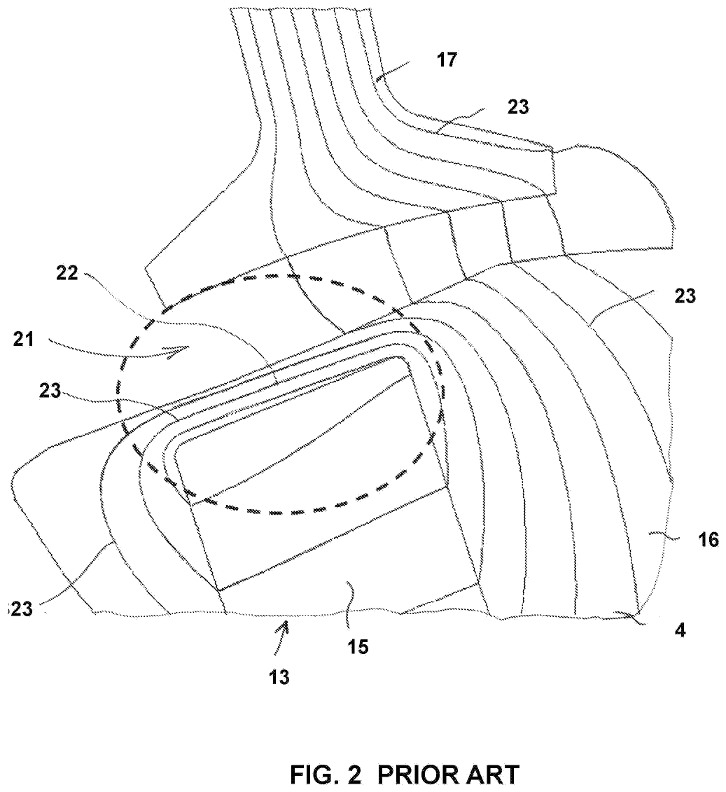

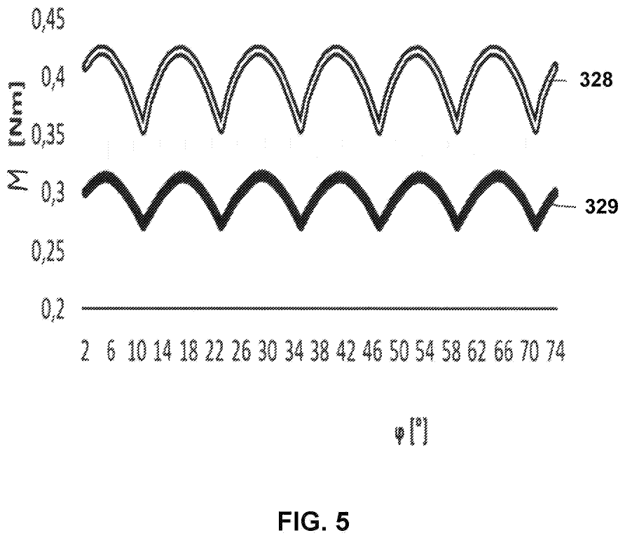

FIG. 5 presents a diagram showing a functional relationship between a torque M generated by the permanently excited electric motor 302 according to the invention and an angular position φ of the rotor 304 by a line 328 that is unfilled on an inside. A solid line 329 represents the same functional relationship for a permanently excited prior art electric motor 2 which includes the bridges 22 in the rotor body according to FIGS. 1 and 2. The torque M of the permanently excited electric motor 302 according to the invention is greater than the torque M of the prior art electric motor 2 for all angular positions φ of the rotor 4.

### REFERENCE NUMERALS AND DESIGNATIONS

1 electric machine

2 electric motor

3 generator

4 rotor

5 shaft

6 balancing disc

7 recess

11 first end section

12 second end section

13 recess

14 rotation axis

15 permanent magnet

16 lamella

17 stator

18 electromagnet

19 roller bearing

20 housing

21 air gap

22 bridge

23 magnetic flux line

301 electric machine

302 electric motor

304 rotor

305 shaft

308 hub body

309 segment

310 rotor body

313 recess

314 rotation axis

315 permanent magnet

316 lamella

317 stator

318 electromagnet

321 air gap

323 magnetic flux line

324 opening

325 rim

326 hook

327 recess

328 unfilled line

329 solid line

330 radially outer circumferential surface

M torque

φ angular position of rotor

What is claimed is:

1. A permanently excited electric machine, comprising:
a stator;
a rotor rotatable within the stator on a shaft about a rotation axis;
an air gap is arranged between a radially outer circumferential surface of the rotor and a radially inner circumferential surface of the stator;
recesses formed in a rotor body of the rotor; and
permanent magnets received in at least two of the recesses,
wherein the at least two recesses that receive the permanent magnets are open towards the air gap.

2. The permanently excited electric machine according to claim 1,
wherein openings are formed in the radially outer circumferential surface of the rotor body, and
wherein the openings lead on a first side into the at least two recesses and on a second side into the air gap.

3. The permanently excited electric machine according to claim 2,
wherein a rim of the openings respectively protrudes in a radial direction of the openings so that the permanent magnets received in the at least two recesses are each respectively partially overlapped by the rim.

4. The permanently excited electric machine according to claim 1, wherein the permanent magnets are arranged like spokes about the rotation axis of the rotor.

5. The permanently excited electric machine according to claim 1,
wherein the rotor body includes segments made from at least one type of metal, and
wherein the segments are arranged like spokes about the rotation axis of the rotor and arranged between the permanent magnets viewed in a circumferential direction in the rotor.

6. The permanently excited electric machine according to claim 5, wherein the segments are separate segments.

7. The permanently excited electric machine according to claim 5, wherein the segments are respectively made from plural lamellas that are stacked in a direction of the rotation axis to form lamella packets.

8. The permanently excited electric machine according to claim 5, wherein the segments are made from steel or include steel.

9. The permanently excited electric machine according to claim 5, wherein the segments are connected at radially inner circumferential surfaces of the segments with a hub body that is connected with the shaft at least torque proof.

10. The permanently excited electric machine according to claim 9, wherein the segments are connected with the hub body by positive form locking, friction locking or bonding.

11. The permanently excited electric machine according to claim 10, wherein the hub body includes radially outer hooks that cooperate with complementary hook-shaped recesses at the radially inner circumferential surfaces of the segments so that positive form locking with an undercut cross section is respectively provided between the radially outer hooks and the complementary hook shaped recesses.

12. The permanently excited electric machine according to claim 9, wherein the hub body is made from a diamagnetic or paramagnetic material.

13. The permanently excited electric machine according to claim 12, wherein the hub body is made from aluminum.

14. The permanently excited electric machine according to claim 1 implemented as a brushless direct current motor (BLDC).

15. The permanently excited electric machine according to claim 1, implemented as a permanent magnet synchronous motor (PMSM).

16. A vehicle, comprising: the permanently excited electric machine according to claim 1.
